(19) United States
(12) Patent Application Publication
(10) Pub. No.: US 2007/0240591 A1
(43) Pub. Date: Oct. 18, 2007

(54) Machine with Temperature Monitoring of a Roller

(76) Inventors: Helmut Hampl, Hassloch (DE); Sebastian Alois Prum, Kaiserslautern (DE)

Correspondence Address: Douglas R. Hanscom;Jones, Tullar & Cooper, P.O.Box 2266, Eads Station, Arlington, VA, 22202, US

(21) Appl. No.: 11/587,661

(22) PCT Filed: Feb. 4, 2005
(86) PCT No.: PCT/EP05/50481

§ 371 Date: Oct. 26, 2006

(30) Foreign Application Priority Data
Apr. 26, 2004 (DE) 102004020302.4

(51) Int. Cl. B41F 5/00; G01K 13/08

(52) U.S. Cl. 101/216; 374/153

(57) ABSTRACT

The temperature of a machine, which includes a rotating cylinder, and at least one roller that rotates with the cylinder, is maintained. The rotating cylinder carries a plate. The machine is provided with at least one temperature sensor for detecting the temperature of the roller.

### CROSS-REFERENCE TO RELATED APPLICATIONS

This patent application is the U.S. national phase, under 35 USC 371, of PCT/EP2005/050481, filed Feb. 4, 2005; published as WO 2005/101951 A2 and A3 on Nov. 3, 2005 and claiming priority to DE 10 2004 020 302.4, filed Apr. 26, 2004, the disclosures of which are expressly incorporated herein by reference.

### FIELD OF THE INVENTION

The present invention is directed to a machine with temperature monitoring of a roller. A machine with temperature monitoring is used to monitor the temperature of a rotating cylinder and at least one roller which is rotating with the cylinder and which roller traces a cam disk which is associated with the cylinder.

### BACKGROUND OF THE INVENTION

In the production of printed products from paper webs, there are numerous process steps in which paper is cut, perforated, or is otherwise separated. In these processes, it is inevitable that paper dust is produced, which paper dust settles inside a workshop onto the devices performing such a printing operation. At the same time, transmission lubricants and lubricating oils that escape from bearings of the printing presses or from other associated machines are pulverized into microscopically fine particles, which particles are distributed throughout the workshop by air circulation. Like the paper dust, these microscopic oil droplets also settle on the various devices inside the workshop. A very flammable mixture of paper dust and oil thus forms. Such a flammable mixture is often found on the roller and on the cam disk and the cover disk of the folding apparatus and in its immediate vicinity.

Because the rollers rotate quite rapidly, typically at speeds of up to 7,000 to 7,500 rpm, wear on the roller tracing or following the disk or disks is correspondingly high, such that damage to the roller or to a bearing of the roller occurs quite often. At these high rotational speeds of the cylinder, a damaged roller or a damaged bearing leads, in turn, to the generation of considerable frictional forces between the roller and the disk or disks, as well as in the bearing. A result is that rapid increases in the temperature of the roller may occur within a few seconds, which elevated temperatures can easily exceed the flash point of the paper dust/oil mixture. The mixture is very easily ignited by such elevated temperatures. In the case of severe damage to the roller, flying sparks may even occur, which flying sparks can easily set the flammable mixture on fire. Therefore, severe or extremely severe fires occur periodically in printing operations, which fires are often caused by the paper/oil mixture and by defective rollers or bearings.

U.S. Pat. No. 5,141,333 A describes a device for detecting the temperature of a rotating, heated toner roller.

DE 44 42 154 A1 discloses a method for initiating a premature roller change. A contact-free temperature measurement is conducted on the face of the roller.

DE 37 34 018 A discloses a device for measuring the temperature of the surface of a rotating roll. Here, the radiated energy is detected by a radiation pyrometer.

U.S. Pat. No. 5,019,692 A and DE 39 04 122 A1 describe temperature measurement systems used on rotating bodies.

### SUMMARY OF THE INVENTION

The object of the present invention is to provide temperature monitoring on a roller in a machine.

The object is attained according to the present invention by the provision of a machine with temperature monitoring that is usable with a rotating cylinder having a cam disk and a cover disk both of which disks are traced or followed by cam rollers. The temperature monitoring machine detects the temperature of the cam disk or the cover disk follower roller, which roller is used to transmit movement, through a control lever, to a tool which is able to perform work relative to the cylinder.

In the machine according to the present invention, the temperature of the roller may be monitored by the use of a temperature sensor. If an increase in the temperature is registered, critical overheating may be prevented because the machine may be switched off, for example in response to the registered temperature increase.

The temperature sensor may be disposed in direct thermal contact with the roller or with a bearing of the roller. Because such a sensor must rotate along with the roller, it is quite laborious to transmit the measurement results, which are acquired by the sensor, to a stationary analysis unit. Therefore, a contact-free temperature sensor, such as, for example, an infrared pyrometer, is preferably used to measure the temperature.

A contact-free temperature sensor of this type may be mounted in a fixed fashion relative to a machine frame in which the cylinder may be supported in a rotatable fashion, and always measures the temperature of the roller, when the roller passes through a detection range of the sensor. In comparison with the embodiment, in which the temperature sensor is moving with the cylinder, this embodiment, using a contact-free temperature sensor, has a considerably simpler construction and is more cost effective. One individual sensor is able to monitor several rollers. In addition, the transmission of a measurement signal from a stationary temperature sensor may be conducted without a problem. Furthermore, stationary temperature sensors may be built into the machine simply and efficiently, even when retrofitting preexisting machines.

In a preferred embodiment of the present invention, the temperature-sensing machine includes an analysis unit, which compares the temperature that is detected by the temperature sensor to a predetermined threshold value and stops the rotation of the cylinder as soon as the temperature sensed by the temperature sensor exceeds the threshold value.

If the machine has n rollers, where n≧2, and which rollers pass through a detection range of the temperature sensor in each rotation period T, then, in this case, the temperature sensor will detect the temperature of each of the rollers and will produce a temperature signal that contains a low-frequency spectral component at the frequency 1/T, and a high-frequency component at the frequency n/T. In this embodiment of the temperature-sensing machine, the analysis unit is able to compare the intensity of the low-frequency spectral component, or the ratio of this low-frequency intensity to the intensity of the high-frequency spectral component, with a predetermined threshold value. The analysis unit will stop the cylinder as soon as the intensity or as soon as the ratio exceeds the threshold value.

In a more advanced embodiment of the temperature-sensing machine in accordance with the present invention, the machine also includes a signal transmitter with which the analysis unit transmits an acoustic and/or an optical warning signal, as soon as the temperature or the intensity or the ratio exceeds the threshold value. In this manner, responsible personnel may be alerted at the onset to possible damages that can be the result of high temperatures. The signal transmitter may, for example, be a signal horn or a siren. However, it may also be a warning lamp or a blinking light. A screen or a display panel, that shows an error message, is also appropriate for use as a signal transmitter. Several signal transmitters may also be provided that, for example, cooperate to emit an optical warning signal as well as an acoustic one. For example, an acoustic warning signal may serve to attract a person's attention, while an optical warning signal, which is occurring in a parallel manner, such as an error message shown on a screen, may inform the person of the cause of the acoustic warning signal.

It is practical for the analysis unit to be integrated into a control panel of the machine. That control panel may also include the signal transmitter. For example, the signal transmitter may be a computer screen on which the analysis unit displays the roller temperature which detected by the temperature sensor in addition to displaying the optical warning signal. It is also possible for the evaluation unit to detect, based on a relative phase position of the 1/T component of the temperature signal for the rotation of the cylinder, which of n rollers is defective and to display this information on the signal transmitter.

The cylinder preferably includes at least one tool or group of tools that is able to perform a work motion with regard to the cylinder. Such a tool or group of tools is connected to the control lever which is carrying at least one of the rollers, which roller or rollers is or are usable for driving the work motion in response to the contour of the disk which is traced, followed or scanned by the roller. Normally, the disk is described as a control disk when it is fixed in place relative to a machine frame, in which frame the cylinder is supported in a rotatable fashion.

In addition to the control disk, it is preferable for a second disk, also often referred to as a cover disk, to be provided in the machine. In one embodiment of the machine, the control lever carries a second roller for tracing, following or scanning this second disk. In an alternative embodiment of the present invention, a second control lever is present, which second control level is provided having a second roller that is scanning the second disk. The first control lever that is connected to the roller which is tracing, following or scanning the control disk and the second control lever may be pivotable around a common axis in order to control the movement of the tool which is assigned to them. The contour of the second disk or cover disk determines whether or not the tool performs a work motion that is programmed by the contour of the control disk, which is being scanned at the same time. The cover disk may be rotated around the axis of the cylinder, possibly at a different angular speed than that of the cylinder. This sort of arrangement is shown, for example, in DE 38 28 372 A1 for use with a perforation and fold measurement cylinder.

When an individual temperature sensor sees rollers which are tracing, following or scanning two different disks, the sensor detects only an average temperature of the two rollers. This reduces the sensitivity of the temperature sensor. If the machine has rollers that trace or follow or scan two different disks, it is therefore particularly preferable for at least two temperature sensors to be used. A first temperature sensor detects the temperature of the roller or rollers tracing, following or scanning the control disk and a second temperature sensor detecting the temperature of the roller scanning the cover disk.

The tool or group of tools, whose working motion is actuated by the disks, rollers, and control levers, may be any tool. Preferably, however, the tool or the group of tools is a sheet end gripper or a puncturing strip or a folding knife or a folding blade. It is also possible for the cylinder to have several different tools or groups of tools, such as in the case of a puncturing and folding blade cylinder that has puncturing strips and folding blades as tools.

The machine which includes one cylinder whose roller temperature is subject to measurement is preferably a folding apparatus, and in particular is a folding apparatus in a web-fed printing press or in a sheet-fed printing press and having a gripper setting of a cylinder for transporting sheets.

### BRIEF DESCRIPTION OF THE DRAWINGS

A preferred embodiment of the present invention is shown in the drawings and will be described in greater detail in the following.

Shown are:

FIG. 1 a perspective view of a portion of a cylinder in accordance with the present invention; in

FIG. 2 an exploded perspective view of the control device with two control levers of a folding blade of the cylinder from FIG. 1; in

FIG. 3 a perspective view of a simplified control device with a control lever with two rollers mounted thereon; in

FIG. 4 a schematic end view of the control device; in

FIG. 5 a graphical depiction of a first signal sent by one of the temperature sensors; and in

FIG. 6 a graphical depiction of a second signal sent by one of the temperature sensors.

### DESCRIPTION OF THE PREFERRED EMBODIMENT

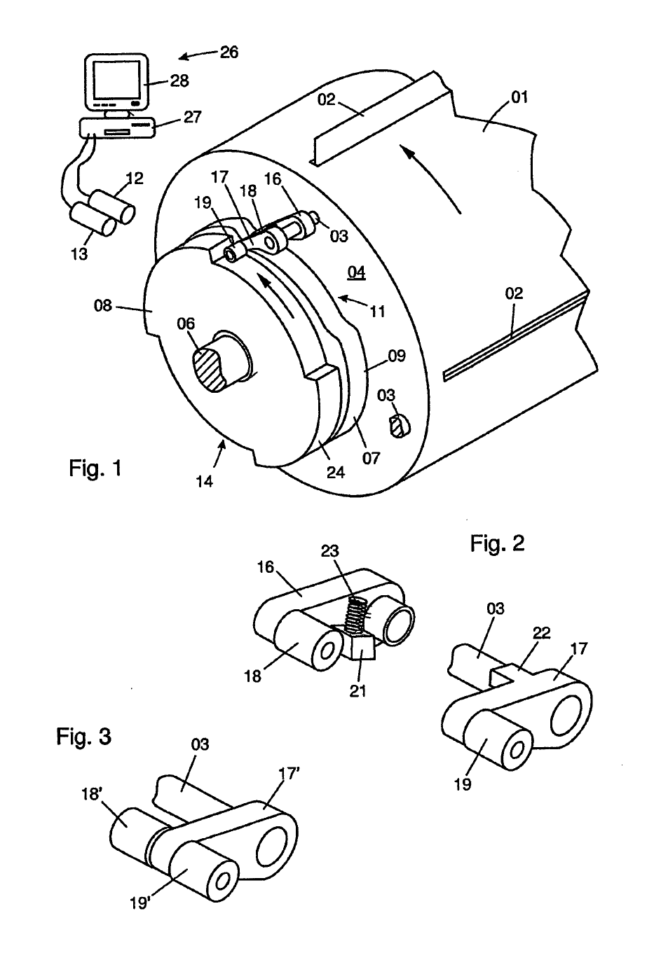

FIG. 1 shows, by way of example, a perspective view of an end section of a rotatable cylinder 01, which cylinder 01 is rotatably mounted in a side frame, which is not specifically shown of a printing machine. The rotatable cylinder is depicted as having three tools 02 or groups of tools, such as, for example, folding blades 02, each of which may be extended from one of a plurality of slots which are arranged in intervals of 120° with respect to each other in the jacket surface of the cylinder 01. Only two such tools 02 on tool groups are visible in FIG. 1. Furthermore, the cylinder 01 carries three sheet end puncturing strips or grippers that are not shown here, which strips or grippers serve to hold a leading end of a signature, which is supplied to the cylinder 01, on the surface of cylinder 01. The distance from the gripper to the folding blade 02 is typically adjustable. In the course of the rotation of the cylinder 01, a signature which is transported onto the jacket surface of the cylinder 01, and which is held by the puncturing strips or by the grippers, passes through a transfer gap between the cylinder 01 and a folding jaw cylinder, which is not specifically shown. The folding blades 02 extend from the surface of the cylinder 01 at the transfer gap. The signature is thus pressed into a folding jaw of the folding jaw cylinder and is thus folded, along its middle, in a transverse manner. While the signature is clamped in the folding jaw, the puncturing strips or the grippers of the cylinder 01 release the signature in order to complete the transfer of the signature to the folding jaw cylinder.

To be able to load a subsequent signature onto the jacket surface of the cylinder 01 after the transfer of the previous signature, the folding blades 02 must pull back into the interior of the cylinder 01. For this purpose, the folding blades 02 are each connected, in a fixed manner, to a shaft 03 by the use of arms which are covered by the jacket of the cylinder 01. As seen in FIG. 1, each shaft 03 is pivotably mounted in the two opposing face plates 04 of the cylinder 01. Cylinder journals 06, which are connected to end or face plates 04 of the cylinder 01, are rotatably mounted in a side frame, which is not shown. A first disk 07, such as, for example, a control disk 07, and a second disk 08, such as, for example, a cover disk 08, are provided coaxially to the cylinder journals 06 shown in FIG. 1. The control disk 07 has essentially the shape of a circular disk that is concentric to the rotational axis of the cylinder 01 and into whose circumferential surface 09 an indentation 11 has been formed. The circumferential surface 24 of the cover disk 08 also has indentations 14 formed in it.

Each of the tool operating three shafts 03 of the cylinder 01 carries two control levers 16; 17, which two control levers 16, 17 together form a control device for controlling the movement of one of the folding blades 02. For the sake of clarity, the control levers 16; 17 are shown on only one of the shafts 03 in FIG. 1. On its free end, a first control lever 16 carries a first roller 18, which rolls on the circumferential surface 09 of the control disk 07. Analogously, the second control lever 17 carries a second roller 19 that rolls on the circumferential surface 24 of the cover disk 08. The second control lever 17 is connected to the shaft 03 in a fixed manner, while the first control lever 16 may be rotated around the shaft 03.

Several rollers 18; 19 may be arranged next to each other in the axial direction of the cylinder 01.

The two control levers 16; 17 each carry a protrusion 21 and 22 on their lateral side facing the other control lever 16; 17, as can be seen from the exploded detail view of the control device shown in FIG. 2. Between the two protrusions 21; 22 there is positioned a pressure spring 23 that pushes the two protrusions 21; 22 apart from each other. The torque of a second spring, which is not specifically shown that may be placed in the cylinder 01, for example, acts on the second control lever 17 through the shaft 03. The second spring presses its roller 19 against the circumferential surface 24 of the cover disk 08. In the setting which is shown in FIG. 1, the first roller 18 rolls in the indentation 11 and the second roller 19 rolls in one of the indentations 14. When the first roller 18 rolls outside the indentation 11 on the circumferential surface 09 of the control disk 07 while the second roller 19 is across from an indentation 14 on the cover disk 08, the second roller 19 is not in contact with the cover disk 08. This contact is prevented by a contact between the protrusions 21; 22 and by the roller 18 of the first control lever 16, which is, at the same time, rolling outside the indentation 11 on the circumferential surface 09 of the control disk 07. During the entire rotation of the cylinder 01, the first roller 18 is in contact with the control disc 07 and is thus rotationally driven at the same rate as the control disk 07. If the roller 18 enters into the indentation 11, this leads to a movement by the folding blades 02 only if, at the same time, the second roller 19 is located across from an indentation 14 of the circumferential surface 24 of the cover disk 08, as is shown in FIG. 1. If this is not the case, then the second roller 19 loses contact with the surface of the cover disk 08 and slows down until it has passed by the indentation 14 and again comes into contact with the surface 24 cover disk 08.

FIG. 3 shows a simplified control device in a perspective view which is analogous to FIG. 2. An individual control lever 17′ is attached to the shaft 03 and carries two rollers 18′; 19′ for rolling on the control disk 07 and/or the cover disk 08, respsectively. The control lever 17′ pivots radially inwards only when both rollers 18′; 19′ pass the indentation 11 and the indentation 14, respectively, at the same time.

A similar control mechanism, with control and cover disks 07; 08, with control levers 16; 17; 17′ as well as with rollers 18; 19; 18′; 19′ is provided on the opposite face of the cylinder 01 and is usable for controlling the puncturing strips or grippers, which are not specifically shown, and by which signatures that are loaded on the jacket surface of the cylinder 01 are held.

In the press side frame, which is also not shown, a first pyrometer 12 and a second pyrometer 13 are held as contact-free temperature sensors 12; 13. The first pyrometer 12 is aligned with its line of sight on the circumferential surface 09 of the control disk 07. The second pyrometer 13 is aligned with its line of sight on the circumferential surface 24 of the cover disk 08. Both pyrometers 12; 13 are connected to a control station 26 that serves to control the machine with the cylinder 01 shown.

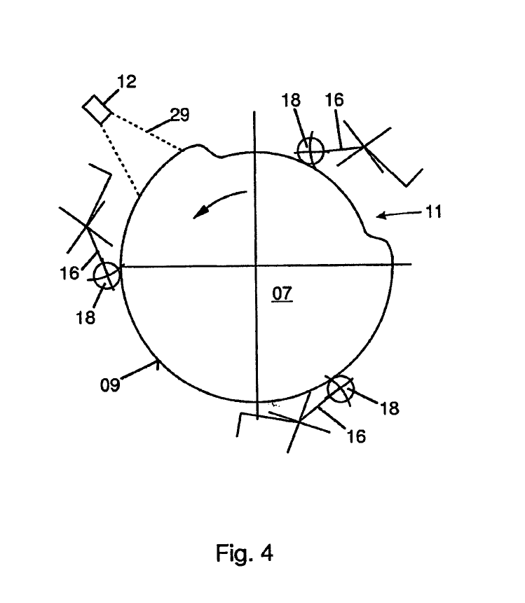

The mode of operation of the temperature monitoring of the control device by the pyrometers 12; 13 will be described using the example of the first roller 18 of the control lever 16, which traces, follows or scans the control disk 07. It will be understood that, in the case of the second roller 19, the temperature monitoring occurs in a corresponding fashion by use of the second pyrometer 13. For this purpose, FIG. 4 shows the control disk 07 with the pyrometer 12 in a schematic front view. Because the control disk 07 is built into the side frame in a fixed manner, and the cylinder 01 rotates, the three rollers 18 roll in a counterclockwise direction on the circumferential surface 09 of the control disk 07. With each rotation of the cylinder 01, each of the rollers 18 traverses a detection range 29 of the pyrometer 12, which detection range 29 is shown in FIG. 4 in dashed lines, one time during each cylinder revolution. For each transversing of the detection range 29, the first pyrometer 12 detects the temperature of the first roller 18 in question. The first pyrometer 12 sends its detected temperature to a computer 27, for example, of the control station 26, which computer serves as an analysis unit 27, and which compares the detected temperature to a predetermined threshold value. In addition, for example, a graphic representation progression of the temperature over time may be provided on a signal generator 28, such as, for example, a screen 28.

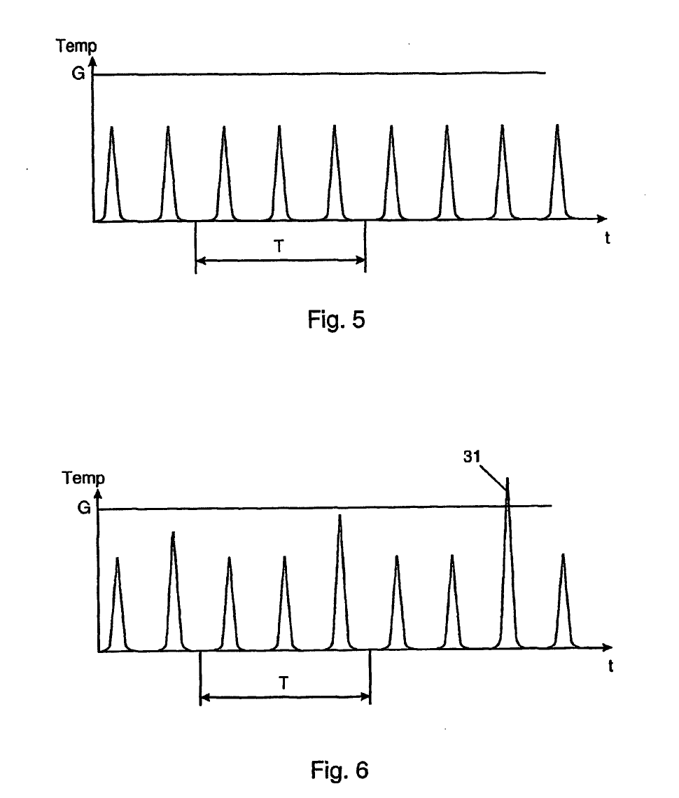

FIG. 5 is a graphical depiction of the temperature Temp which is detected by the first pyrometer 12 as a function of time t. T designates the period duration of one rotation of the cylinder 01. G is the predetermined threshold value. Because three rollers 18 are present, the pyrometer 12 detects three maximums of the temperature Temp during the period duration T, each of which temperatures Temp corresponds to one of the rollers 18 passing through the detection range 29 and the temperature Temp of the roller 18 in question. If all of the rollers 18 are undamaged, all of the rollers 18 will each have approximately the same temperature Temp. As long as none of the maximums exceeds the threshold value G, all of the rollers 18 are in order.

As soon as one of the rollers 18, or its bearings, is damaged, such as, for example, as a result of wear or material fatigue, increased friction occurs between the damaged roller 18 and the cover disk 07 or within the bearing of the roller 18. The result is that the temperature Temp of the roller 18 in question increases in comparison to that of the other rollers 18. In this case, the pyrometer 12 produces the signal shown in FIG. 6, in which every third maximum corresponding to the temperature Temp of the damaged roller 18 is elevated in comparison to the maximum of the other two intact rollers 18. Because the temperature Temp of the damaged roller 18 increases, the signal peak belonging to this roller 18 continues to increase over time. For example, each roller 18 may be identified using the angle position of the cylinder 01. As soon as the temperature of the damaged roller 18, and thus the magnitude of the growing signal peak, exceeds the threshold value G, as is the case for the signal peak 31 in FIG. 6, a warning signal is produced by the computer 27 such as by way of the signal generator, for example on the screen 28 in the present case. The machine or the cylinder 01 is then stopped, such as, for example, by the use of an emergency stop.

Instead of the individual temperature maximums of the rollers 18 being compared to the threshold value G, the computer 27 may also detect a malfunction of the roller 18 using a spectral analysis of the temperature signal of the pyrometer 12 or 13. If n is the number of rollers 18 in the circumferential direction of the cylinder 01 that pass through the detection range 29 in each rotation period T of the cylinder 01, then the frequency n/T has the strongest spectral component of the temperature signal. If all rollers 18 have the same temperature Temp, then the intensity of a spectral component with the frequency 1/T is negligible. Such a component occurs with significant intensity only if the temperature Temp of one roller 18 deviates from that of the others. A malfunction of the roller 18 may therefore be recognized when the intensity of the component with the frequency 1/T, or the ratio of this intensity to the component with the frequency n/T exceeds an appropriate predetermined threshold value G. This may be determined in a simple manner, in that the component with the frequency 1/T is extracted from the temperature signal with the aid of an electronic filter and its intensity is evaluated. Two filters may be used to extract the components with the frequencies 1/T and n/T and their ratio is evaluated. From the relative phase position of the 1/T component for the rotation of the cylinder 01, the computer 27 may moreover detect which of the several rollers 18 is defective and can then display this information on the screen 28.

Instead of the three folding blades 02 or puncturing strips with puncturing needles, grippers, or folding jaws, the cylinder 01 may also have five or seven sections, with five or seven tools 02 or groups of tools, and in particular groups of folding blades 02 or puncturing strips with puncturing needles, or grippers, or folding flaps. Preferably, the cylinder 01 has at least two rollers 18 in the circumferential direction, and preferably has n rollers 18, where n is a whole number, preferably 2, 3, 5, or 7.

In the preferred embodiments described above, the folding blades 02 were viewed simply as examples of tools that are attached to the cylinder 01 and which are periodically activated. However, it is to be understood that the present invention may apply, in the same manner as described above, even to other periodically moved tools 02 such as grippers, puncturing strips with puncturing needles, folding flaps, and the like.

While preferred embodiments of a machine with temperature monitoring of a roller, in accordance with the present invention, have been described fully and completely hereinabove, it will be apparent to one of skill in the art that various changes in, for example, the overall structure of the printing press, the drives for the cylinder and the like could be made without departing from the true spirit and scope of the present invention which is accordingly to be limited only by the appended claims.

What is claimed is:

1-28. (canceled)

29. A cylinder assembly comprising:
a rotatable cylinder;
at least one tool carried by said cylinder and adapted to perform a work motion relative to said cylinder;
a first control lever connected to said at least one tool and operable to cause said work motion of said tool;
a roller on said control lever;
a control disk adjacent said cylinder and having a control surface adapted to be traced by said roller to cause said work motion of said tool; and
at least one temperature sensor usable to detect a temperature of said roller.

30. The cylinder assembly of claim 29 wherein said temperature sensor is spaced from said roller and out of physical contact with said roller.

31. The cylinder assembly of claim 29 wherein said temperature sensor is a pyrometer.

32. The cylinder assembly of claim 29 wherein said cylinder carries a plurality of said roller arranged in a circumferential direction of said cylinder.

33. The cylinder assembly of claim 29 further including a central station and an evaluation unit connected to said temperature sensor.

34. The cylinder assembly of claim 29 further including at least first and second ones of said rollers arranged adjacent each other in an axial direction of said cylinder.

35. The cylinder assembly of claim 29 further including a cover disk associated with said cylinder and a second roller on said control lever, said second roller being in engagement with said cover disk.

36. The cylinder assembly of claim 35 further including a second control lever supporting said second roller, said first control lever and said second control lever being pivotable about a common axis.

37. The cylinder assembly of claim 34 further including a second temperature sensor, said one temperature sensor detecting a temperature of said first roller, said second temperature sensor detecting a temperature of said second roller.

38. The cylinder assembly of claim 32 wherein said plurality of rollers is at least two of said roller.

39. The cylinder assembly of claim 38 wherein a number of said rollers is selected from three, five and seven.

40. The cylinder assembly of claim 29 wherein said tool is one of a folding blade, puncturing strip, gripper and folding jaw.

41. The cylinder assembly of claim 29 wherein said cylinder is part of a folding apparatus.

42. The cylinder assembly of claim 41 wherein said folding apparatus is in a rotary printing press.

43. The cylinder assembly of claim 29 wherein said cylinder is part of a sheet printing press.

44. A method for monitoring a temperature in a cylinder assembly including:
providing a rotatable cylinder;
carrying at least one tool, which is adapted to perform a work motion with respect to said cylinder, on said cylinder;
providing at least one control lever for effecting said work motion of said at least one tool;
positioning at least one roller on said control lever;
locating a control disk adjacent said cylinder;
engaging said control disk with said roller for accomplishing said work motion;
providing a temperature sensor; and
using said temperature sensor for detecting a temperature of said roller.

45. The method of claim 44 further including providing a plurality of said rollers on said cylinder, providing a detection range for said temperature sensor, passing each of said rollers through said detection range in each rotation period of said cylinder, and using said temperature sensor for producing a measurement signal which is representative of temperatures of said rollers.

46. The method of claim 45 further including providing said measurement signal containing a high-frequency spectral component having a frequency n/T wherein n is said plurality of rollers and T is said rotation period.

47. The method of claim 46 further including providing said measurement signal containing a low-frequency spectral component having a frequency 1/T.

48. The method of claim 47 further including providing an evaluation unit and using said evaluation unit for comparing ones of an intensity of said low-frequency spectral component and a ratio of said low-frequency spectral component intensity to an intensity of said high-frequency spectral component to a predetermined threshold value.

49. The method of claim 48 further including using said evaluation unit for stopping a rotation of said cylinder when said one of said intensity and said ratio exceeds said threshold value.

50. The method of claim 48 further including providing a signal generator and using said signal generator for generating a signal when said predetermined threshold is exceeded.

51. The method of claim 50 further including using said low-frequency spectral component for identifying a defective one of said rollers and indicating said defective roller to said signal generator.

52. The method of claim 44 further including providing a second roller adjacent said first roller and further providing a second temperature sensor and using said second temperature sensor for detecting a temperature of said second roller.

53. The method of claim 45 further including using said temperature sensor for determining which of said plurality of rollers has an elevated temperature.

54. The method of claim 45 further including providing an angular position detector on said cylinder and using said angular position detector for determining which one of said plurality of rollers has an elevated temperature.

55. The method of claim 44 further including providing an evaluation unit, sending a temperature signal from said temperature sensor to said evaluation unit and using said evaluation unit for stopping a rotation of said cylinder.
